(19) United States
(12) Patent Application Publication
(10) Pub. No.: US 2004/0139232 A1
(43) Pub. Date: Jul. 15, 2004

(54) Method and system for content authoring

(76) Inventors: Fabio Giannetti, Bristol (GB); Roger Brian Gimson, Bristol (GB)

Correspondence Address: HEWLETT-PACKARD COMPANY, Intellectual Property Administration, P.O. Box 272400, Fort Collins, CO, 80527-2400, US

(21) Appl. No.: 10/650,638

(22) Filed: Aug. 28, 2003

(30) Foreign Application Priority Data
Sep. 5, 2002 (GB) 0220711.6

(51) Int. Cl. G06F 17/30; G06F 15/16

(52) U.S. Cl. 709/246; 715/530

(57) ABSTRACT

Authoring a document to be served for rendering on a plurality of classes of device comprises defining at least two choices of content which may be styled for a first content portion of the document, defining at least two choices of content which may be styled for a second content portion of the document, and labelling the choices of content to indicate approved combinations of content for the first content portion with content for the second content portion.

This invention relates to a method of authoring content to be served, especially that processed by a web server or web browser or intermediary between the two. It also relates to a system for authoring such content.

It is currently possible to gain access to a web page using a number of different devices, such as a desktop or laptop computer, a personal digital assistant (PDA) in combination with a telephone or a modem link, or directly to a mobile phone by invoking a communication protocol known as Wireless Access Protocol (WAP). Thus, in principle, content posted on a web page, such as text and graphics is accessible by a consumer in possession of any one of these devices who is able also to avail themselves of the requisite network links.

Many web document authoring tools, such as Front Page from Microsoft Corporation and Dreamweaver from Macromedia Corporation exist which provide templates which help the author achieve consistent feel across a set of web pages. However, this is of limited benefit where a set of pages are to be rendered across different devices as it does not take into account the capabilities of the devices unless a “minimum” specification template is used which can lead to low quality results on high capability devices.

Indeed, a significant but, to the lay person, ostensibly trivial difficulty exists in disseminating content to all of these devices in a manner which is usable by a consumer: the device the user is using to make manifest the content may not be capable of manifesting elements of the content essential for comprehension of the information within it. For example, an author may produce a web pages for display on a laptop computer which includes several graphical images that are unsuitable for (or simply impossible to) manifest via WAP on a small, monochrome and extremely low resolution screen.

This problem is well known and is currently addressed in several ways. According to one approach, a separate web page is written for each device or class of devices. Whenever a request for a webpage is made the capabilities of the device are identified and the most appropriate webpage is selected from the set. Whilst this approach ensures the display of the information is optimised for each device it does required a lot of work by the author in writing multiple web pages. Also, if a change of content occurs then all of the web pages in the set need to be individually rewritten.

Using aspects of the present invention it is possible to provide a method and a system for authoring web content which may ameliorate some of the problems which arise when documents are to be rendered across a range of different devices.

According to a first aspect the invention provides a method of authoring a document to be served for rendering on a plurality of classes of device comprising:

defining at least two choices of content which may be styled for a first content portion of the document;

defining at least two choices of content which may be styled for a second content portion of the document; and

labelling the choices of content to indicate approved combinations of content for the first content portion with content for the second content portion.

Such a document could be provided as a web document (ie a document for rendering by a web server, web browser or the like).

By styled content in the context of this application we may mean styled information such as a portion of text and an associated style for the presentation of that text, or perhaps unstyled information such as an image or logo.

Because a number of choices of content are provided and the possible combinations that are allowed are restricted by defining approved combinations the author is given control over the appearance or feel of the document whilst retaining flexibility in the way in which it can be reproduced.

The step of labelling the content to indicate approved combinations may be performed manually by an author, who may be a web designer or perhaps the client of a web designer. This allows complete control over which content is shown with which other content. It allows unpleasant combinations of content to be rejected by the author, perhaps because they do not place the correct emphasis on the content that is most significant, or simply because a particular combination is unattractive.

The method may employ rules whereby choices are deemed allowable if they have the same font, or a consistent font (for example they both belong to a defined set of fonts even if not the same), choices have a common background colour which are to be displayed together, or perhaps text written in the same natural language are to be shown together (i.e Italian or English). Another rule may be that choices form an approved combination if the content has the same reading age.

The method may comprise defining more than one set of approved combinations using the choices of content for the first and second portions, a first set of approved combinations being formed using different rules to a second set of approved combinations. For example, content may be grouped as an allowable combination if it has a common background colour to form the first allowable set, and grouped according to the reading age to form a second set of allowable combinations. It is envisaged that the allowable combinations of the first and second groups will be different although they may have combinations in common.

The method may include an additional step of arranging the allowable choices into class sub-sets, each class sub-set including only those labelled choices which match the properties of a class of devices on which the web document is to be rendered.

By grouping the allowable combinations into class-subsets a first stage selection in which those combinations which do not match the properties of any devices within a class can be made.

More than one class-set may be defined. For example a class set may be formed for PC devices and laptops which have high resolution screens, a class set may be formed for PDAs and a class set for mobile telephone WAP devices.

The web document may comprise a web page, a portion of a web page or a set of web pages which are related to one another in some way. Where it is a single page the use of allowable combinations allows the author to control the look of the page. Where it is a set of pages, the combinations allow the author to ensure that a consistent look is achieved across all pages.

In a further step the method may comprise receiving the properties of a device requesting the web document and selecting from the sub-class of combinations which includes the device requesting the document a set of content which matches the properties of the requesting device.

The properties may comprise physical properties of the device. These may include maximum and/or minimum screen size or area, types of content that may be rendered, maximum permitted screen resolution of the device, maximum number of allowable colours or colour compatibility, supported content languages (i.e. XML, HTML, WAP) etc

In this step, since the choice of document to send the device is made from a set which has already been limited by device class the process is considerably quicker than it would have been if all possible combinations had to be searched to decided which to use.

The step of grouping into sub-classes according to the properties of the device class may comprise applying a set of rules to the content forming each combination in order to determine if it is allowable.

One rule which may be used is to check that the combination of content for the first and second portions fits within a minimum and/or a maximum area available on all of the devices within a class for rendering the content portions.

A different rule which may be applied is to check if all of the content for a combination can be rendered by all of the defined devices within a class. For example, if one of the content choices in a combination is an image and the device class cannot display images that combination is not allowed.

For example, consider a case where the first content portion is the first page of a Website containing a chart and the second content page is an index which contains only text. Since not all devices may render charts an author may provide an alternative first page with no chart yet a larger title, and a second page which has more concise text in a larger font to provide the same feel as the alternative title page. If a device that cannot display charts requests the index page it could be given either of the alternatives, and perhaps is given the first as this has the most content. Then if the device requests the title page it will be sent the alternative with the larger text-leading to an inconsistency of feel across the pages. This is avoided in the present invention since only the combination of the alternatives will be allowed for a device within that class.

Each choice of content may be provided as a separate file or a sub-file of a single file. The class-set may also be stored as a single file or a sub-file within a single file. The files may be in a mark-up language such as the Extensible Mark-up Language (“XML”).

The step of providing content may comprise authoring new content or pre-authored, existing, content may be used. The author of the content may be different, and the labelling of combination of content may be made by the author of the content or by another.

The method may include a step of providing a preference to each choice indicating which combination should be used in preference to another combination should more than one combination in the class be suitable for sending to a requesting device.

A typical preference would be to ensure that the largest size content is always used for a given property of a requesting device, or perhaps the combination or highest graphical content.

The labels for the combinations may be used to indicate the preference. In a simple system, each choice may be labelled by a number and the higher the number the higher the priority for a choice, or perhaps the lower the number the higher the priority. Other label conventions could be used of course, and they need not be numerical labels.

The method may include the step of transmitting to a device making a request for a web document a web document which includes one of the combinations included in the class-subset containing the requesting device which is best suited to that device. For example, although the sub-class does not include content choices which can not be rendered on any device in the subclass it is only when the exact properties of the device are known that the final choice may be made. Some of the choices in the class that will work on a device at the top of the class may not work on devices at the bottom of the class. This two-stage process optimises the speed at which document choice is made.

According to a second, different, aspect the invention provides a system for authoring a document to be served for rendering on a plurality of classes of device comprising:

a content defining tool for defining at least two choices of content which may be styled, for a first content portion of the document and at least two choices of content, which may be styled for a second content portion of the document; and

a labelling tool which permits the author to label the choices of content to indicate allowable combinations of content for the first content portion with content for the second content portion.

The system may include a sub-class selection tool which arranges the allowable choices into class sub-sets, each class sub-set including only those labelled choices which match the properties of a class of devices on which the web document is to be rendered.

The content defining tool may comprise an editor which permits an author to define the identity and location of existing content choices and/or to author new content. It may be adapted to produce a file which includes the content or references the content choices.

The labelling tool may be adapted to render automatically selected choices for an author or other user and request the author or user to indicate if the combination is allowable. Alternatively, the author/user may have complete control over which choices to render during the process of labelling choices. In a very basic form of the invention, it may simply comprise a text editor which allows the user to create a file in which allowable choices are stored according to a set of machine readable rules, e.g. an XML file.

The sub-class selection tool may include a device property agent which is adapted to retrieve the properties of devices which form the class of devices for which the sub-class in based. It may retrieve the properties from a prexisting data file, or perhaps by interrogating one or more actual devices within the class. It may alternatively prompt a user to manually enter one or more properties, such as maximum screen size or area, types of content that may be rendered, maximum permitted screen resolution of the device, maximum number of allowable colours or colour compatibility etc.

According to a third aspect the invention provides a data structure that is suitable for processing to produce a rendered document, the program comprising:

a content defining section defining at least two choices of content which may be styled for a first content portion of the document and at least two choices of content which may be styled for a second content portion of the document; and

a label section which includes labels corresponding to choices of content, each label indicating an allowable combination of content for the first content portion with content for the second content portion.

The data structure may also include a sub-class selection section which includes at least one defined class sub-set, each class sub-set including only those labelled choices which match the properties of a class of devices on which the web document is to be rendered.

There will now be described, by way of example only, two embodiments of the present invention with reference to the accompanying drawings of which:

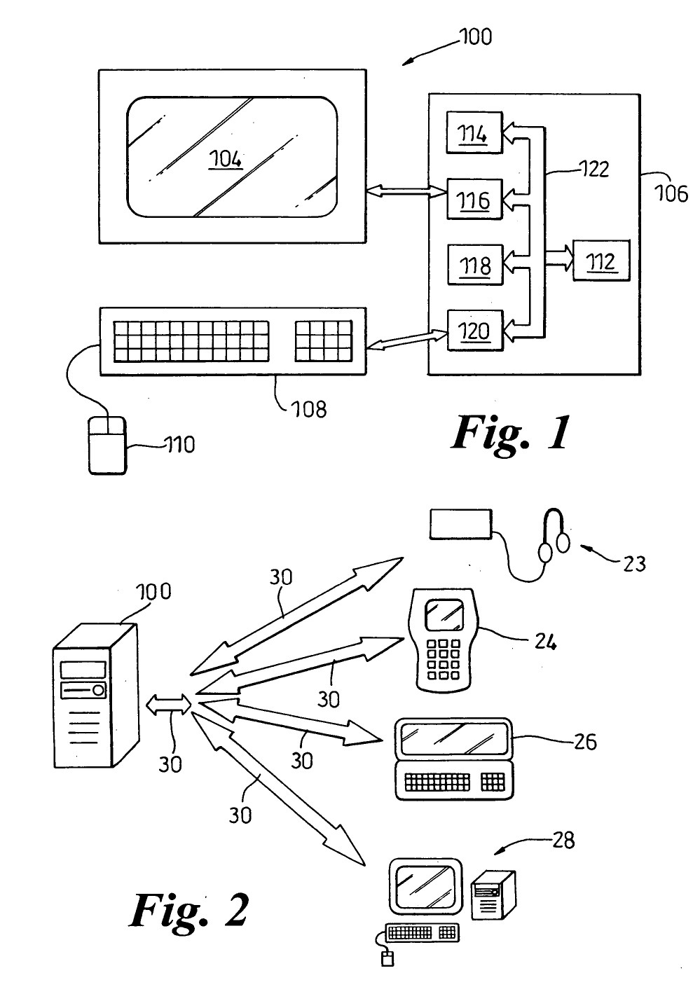

FIG. 1 schematically shows the architecture of a computer capable of acting as a server for this invention;

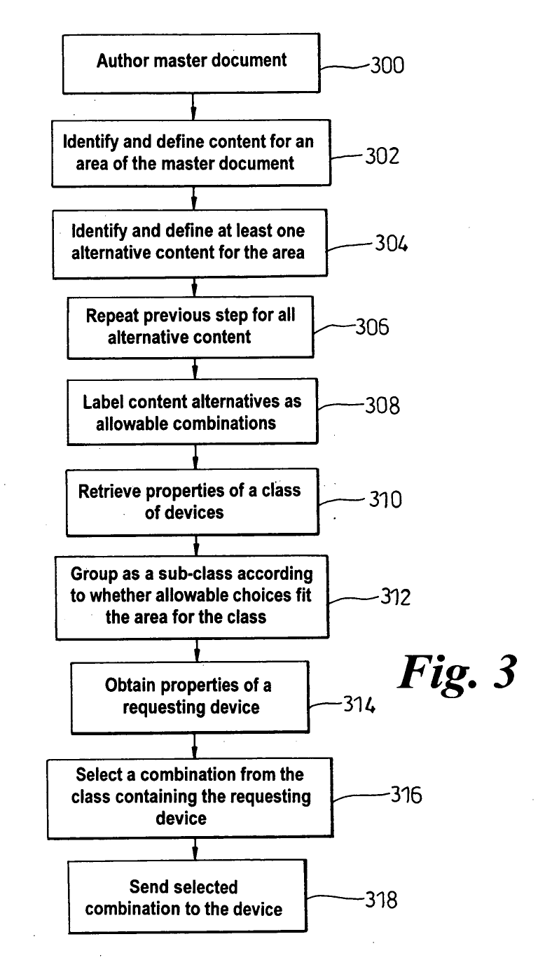

FIG. 2 shows schematically shows an arrangement for sending data according to an embodiment of the present invention;

FIG. 3 shows the steps of a first example of a method in accordance with a first aspect of the invention;

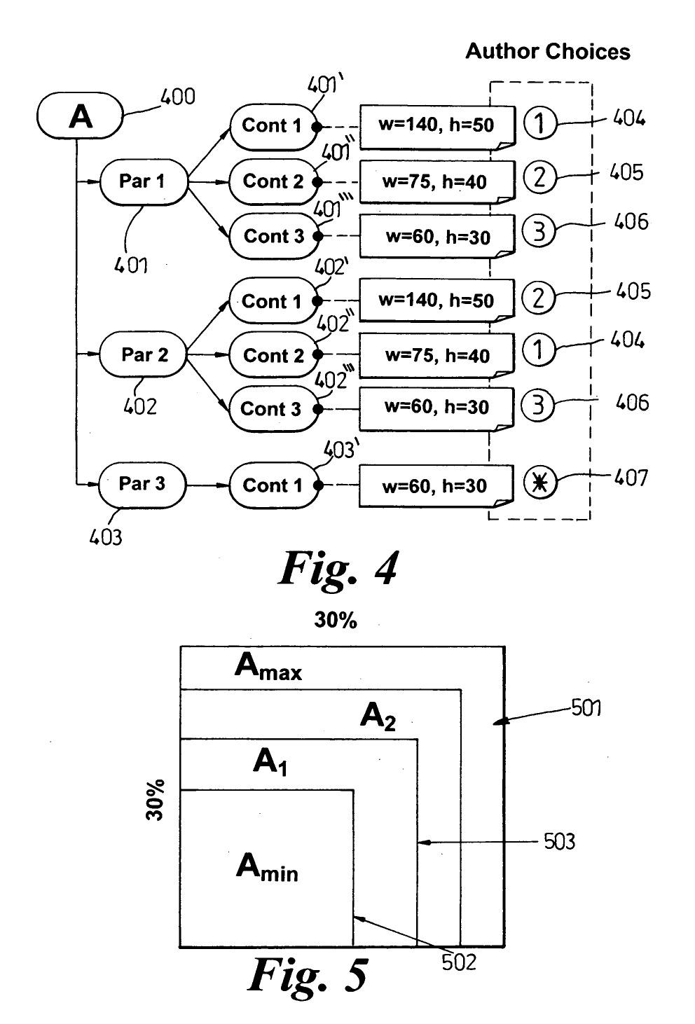

FIG. 4 illustrates the grouping of alternative content for a document into preferred choices;

FIG. 5 illustrates the possible areas within which the content can be fitted for a class of devices;

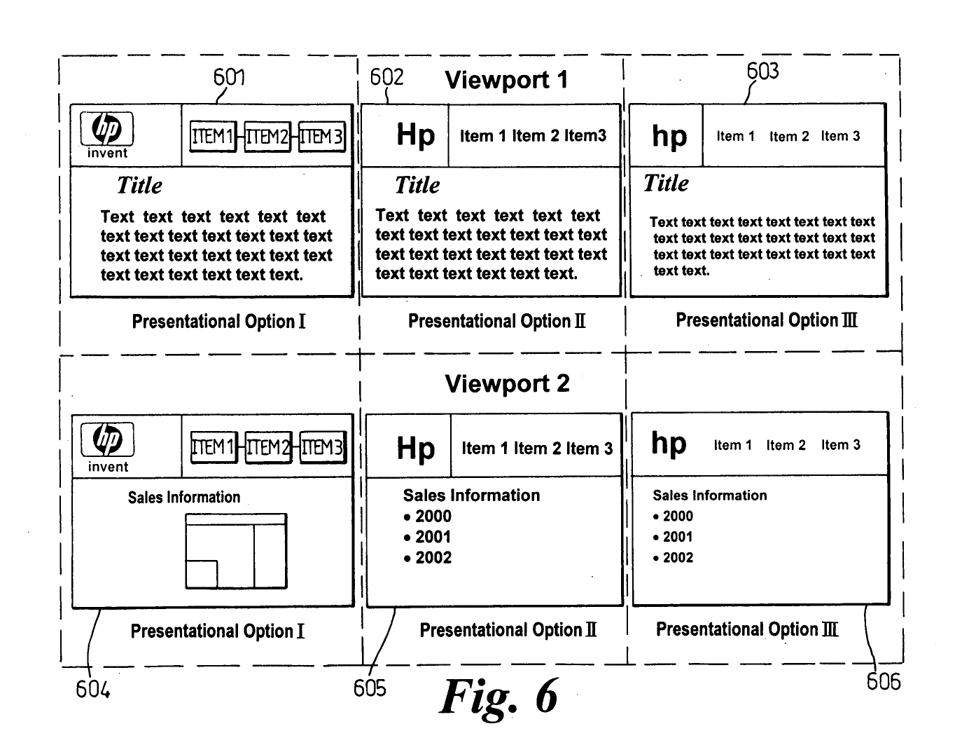

FIG. 6 is an illustration of a selection of pages which form three possible representations of a two-page website; and

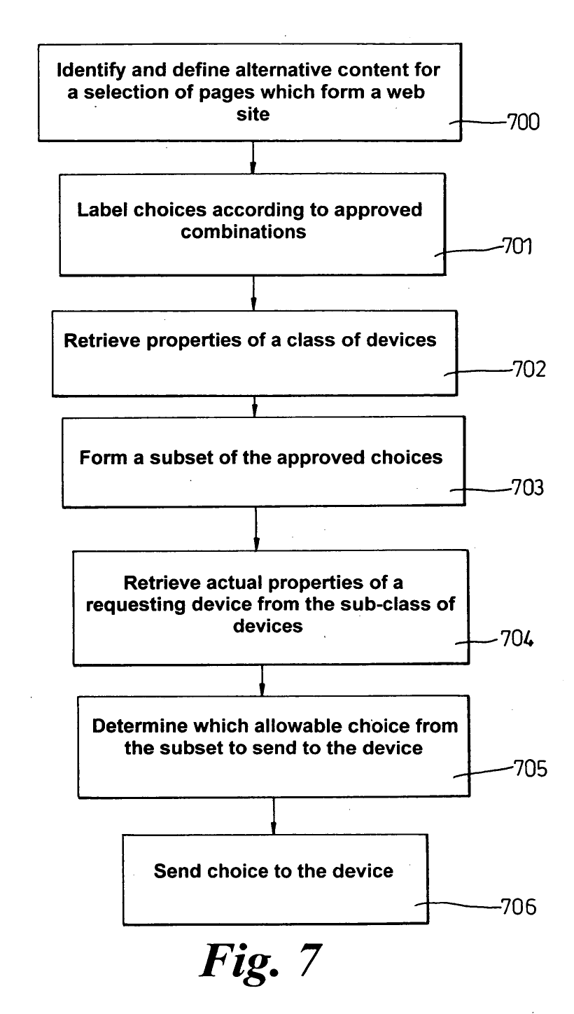

FIG. 7 is a flow chart for a second example of a method in accordance with the first aspect of the invention.

This particular invention is applicable to distribute data electronically, and in particular to serve data by a mechanism such as the World Wide Web, or in short the web. Such technology is well known. Generally the data to be distributed, herein referred to as a web document is held on a processing apparatus or server 2 as shown in FIG. 1 and can be requested by any number of devices that are capable of communicating with the server 2. These devices may be from any one of a class of devices, such as PCs. PDAs, mobile telephones etc.

In the two examples described hereinafter two methods of authoring a document to be distributed and system for same are described which are compatible with the apparatus of FIG. 1. The processing apparatus, or server 100, comprises a display 104, processing circuitry 106, a keyboard 108 and mouse 110. The processing circuitry 106 further comprises a processing unit 112, a hard drive 114, a video driver 116, memory 118 (RAM and ROM) and an I/O subsystem 120 which all communicate with one another, as is known in the art, via a system bus 122. The processing unit 112 comprises an INTEL PENTIUM series processor, running at typically between 900 MHZ and 1.7 GHZ.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive 114 is used as mass storage for programs and other data.

The server 100 could have the architecture known as a PC, originally based in the IBM specification, but could equally have other architectures. The server may be an APPLE, or may be a RISC system, and may run a variety of operating systems (perhaps HP-UX, LINUX, UNIX, MICROSOFT NT, AIX or the like).

In the two examples of the present invention, data—which provides the basis for a web document—is held on the server 100 which stores the data and distributes it on request to a requesting data receiving device. The requesting data receiving device can be any device that is capable of communicating with the server 100 across network connections 30. when the server 2 receives a request from a data receiving device or another device it will forward the requested data required to render the requested page to the requesting device. This is schematically represented by FIG. 2 of the accompanying drawings, which shows an audio only device 23, a WAP enabled mobile telephone 24, a landscape oriented PDA 26 and a PC 28 in communication with the server across a network connection. This list of devices is, it will be appreciated not exhaustive.

In general, devices can be grouped into classes according to common properties of the device such as approximate screen size, number of colours available, ability to display text and or images and or charts or the like. Ideally, a document sent to a device of one class would be different to that sent to another a device of another class in order to optimise the document for each device. Both examples given hereinafter facilitate this requirement to tailor documents to devices.

It has previously been a requirement that content for a document that is to be sent to different devices is stored in a single document on a server and the required content is extracted from this document for display—more being extracted and displayed on a high specification device than a lower specification device. In an alternative, a separate document could be written for a PC and for a PDA, for example. The present invention provides a method of providing a document in which a choice of content for a single document is provided and the finished document is made up of different selections of content from within the choices depending upon the properties of the requesting device. This allows for a more flexible set of published documents to be provided for use with a wide range of requesting devices, content being mixed and matched from the choices of content that are provided.

A first example of a method of authoring a document to be processed by a requesting device in accordance with a first aspect of the invention is illustrated by the flow chart of FIG. 3 of the accompanying drawings.

In this example, the author can tailor documents to different requesting devices according to the screen area of the device. This allows the author to take full advantage of a screen with a large number of pixels and yet still render the document in a meaningful way on a smaller screen with less pixels.

A master document is first authored 300 which defines at least one area into which content is to be fitted when the document is rendered. This may be expressed as a percentage of the total available area where the document is a single page such as a web page. For a simple example lets consider a WebPage having one area A into which content is to be fitted. The area is expressed as a percentage of the available screen size when the document is rendered, as shown in FIG. 5 of the accompanying drawings. In this example it is assumed to be 30 percent of the available screen size. At this stage, the final screen size of a requesting device is assumed to be unknown.

In a second step 302, the author indicates the identity and location of the content which is to be fitted into the area A when the document is rendered. Since the area will be different depending on the size of the screen of a requesting device, the author may want to alter what is shown in each area for a given device.

To allow for choices of content within the area, in the next step 304 one or more alternative content choices for that area are defined. This step is repeated 306 for as many alternatives as the author wishes to provide. In the example illustrated in FIG. 4 of the accompanying drawings, the document has one defined area A, referenced by numeral 400 which is to contain a selection of 3 paragraphs 401, 402, 403 referenced Par 1, Par 2 and Par 3.

For Par 1 the author provides 3 alternative paragraphs—401′, 401″, 401′″. The first choice 401′ has a width of 140 pixels and a height of 50 pixels. The second choice 401″ has a width of 75 pixels and a height of 40 pixels. The third choice 401′″ has a width of 60 pixels and a height of 30 pixels.

For Par 2 the author provides 3 different choices of paragraph 402′, 402″ and 402′″, again having 3 sizes that correspond to those of the choices for Par 1 (i.e. 140 by 50, 75 by 40 and 60 by 30).

For Par 3 only one choice 403′ is given which has a width of 60 pixels and a height of 30 pixels.

Once the content choices 401′-403′ have been defined, the next step 308 is to label the choices to indicate allowable combinations. This step is important as it allows the author control over the appearance of the document. As shown in FIG. 4 three choices are provided labelled with a numbered identifiers 404, 405, 406. A fourth choice 407, which is a wild card, it provided for the paragraph of Par 3. All paragraphs labelled with identifier 406 are intended to be used together, all of identifier 405 together and so on. The wildcard for Par 3 indicates this can be used with any of choices 404, 405 or 406 or on its own. Thus, the author provides 4 combinations which he is happy to have fitted into the allowed area, herein referred to as approved combinations.

Having formed approved combinations, before a requesting device is sent one of these combinations, steps must be taken to ensure that the actual device is only sent combinations which match the properties of the device. This may be performed in many ways, but the remaining steps of FIG. 3 set out one way in which this can be carried out.

The author may provide 310 a range of available screen sizes for a class of devices. The approved combinations are then tested to see if they fit the range of areas and those which do are grouped 312 as a device class sub-set of the combinations. This initial grouping into classes can be performed offline, not in real time, to restrict the choices that can be sent to a requesting device within the class.

For the purpose of this example, lets assume two class sub-sets are to be formed: one for PC devices and one for PDAs. Further, it is assumed that PCs have a range of screen sizes from 800 by 600 pixels up to 1600 by 1200 pixels, and that the PDA class has a range of screen sizes from a minimum of 160 by 160 up to a maximum of 600 by 450 pixels. This gives a maximum 30 percent area of 480 by 360 for PCs and 180 by 125 for the PDA class. The maximum area 501 and the minimum area 502 are shown as Amax and Amin in FIG. 5.

Considering the approved choices in terms of their area in pixels the first choice has the largest area of 220 by 110 pixels and the third the smallest at 120 by 70 pixels. In this example, it can be seen that the first, second and third combinations will all work with a PC device and so the sub-class for PCs will include all the combinations. However, for PDAs the first combination is too large for the area Amax of even the largest device in the class and so is rejected from the PDA sub-class.

After this stage is complete, a set of sub-classes will be formed which include allowable combinations which can be suggested for use with a requesting device in any class of devices.

Having determined a sub-class of approved choices, in a subsequent step 314 the properties of a device making a request may be determined. For the sake of example, consider that the PDA of FIG. 2 makes a request and that it has a screen size which is 180 pixels by 105 pixels. It is noted that this clearly within the range of allowable area defined for the PDA sub-class but that it is not as large as the largest device in that class.

The percentage area (A1) 503 is then calculated as an actual pixel size, giving an actual area of 130 pixels by 80 pixels. The allowable choices of content that can be displayed on the requesting device are then determined 316. In this example, a study of choices 2 and 3 indicates that only choice 3 can be used since choice 2 requires too large an area. Therefore, in a final step 318 a document that includes content corresponding to choice 3 is sent to the requesting device to be rendered.

There may be occasions in which more than one of the choices could be sent to the requesting device. In this case, the choice of combination used is determined according to a predefined hierarchy. For example, the magnitude of the choice number may be used to indicate a priority given to a choice, those with a lower number being used in preference to those with a higher number for instance. This can be used as a way to ensure that the largest size combination is used for any device, or perhaps simply to allow an author to express preferences based upon other properties of the content such as the overall look and/or feel.

This example of the invention therefore provides a method by which a range of content choices can be provided which in a first stage are limited into a sub-class for a range of devices, and in a second stage the best fit choice from the sub-class is sent to a requesting device.

A second example of a method of authoring a document to be processed by a requesting device in accordance with a first aspect of the invention is illustrated in FIG. 6 and with reference to the flow chart of FIG. 7 of the accompanying drawings.

This example differs from the first in that the author indicates combinations of content that span whole pages of a web site rather than combinations of content within one page. Also, rather than using the screen size of a device as the property by which combinations are allowed or excluded from a sub-class, the ability of a device to display particular types of content is considered. This allows the author to ensure a consistent look and feel across all pages of a Website when sent to a device.

Considering again the apparatus of FIGS. 1 and 2 of the accompanying drawings, in a first step 700 of the method of the second example two web pages are defined by an author which provides alternative ways of showing the information contained in each page. As shown in FIG. 6, a web site having 2 pages is proposed, and the author provides 3 alternatives 601,602, 603 for the first page, and three alternatives 604, 605, 606 for the second page.

In a second step 701, the choices of page are labelled by the author to indicate approved combinations. This allows the author to control which pages can be viewed together, allowing for example a consistent feel across the pages. In the example, those first page which are compatible with a second page are shown arranged in vertical columns. The first choice of pages 601, 604 both have a logo image and an outlined style for the list of items. The second example 602, 605 omits the logo and therefore contains no images. The third example 603, 606 is the same as the second example except that the text content is reduced and a larger font is used. It can be clearly seen that each pair in a labelled choice has a similar feel.

As with the first example, labelling the choices in this way allows the author to control the overall feel of a set of pages which are to be presented. A device making a request is limited to combinations which are approved.

Having defined approved choices which can be sent to a device there remains a need to select which of the choices is best sent to any given requesting device. As with the first example this can be performed in many ways but one particularly favoured method of achieving this is set out in the following paragraphs. As with the initial steps, the reader is referred to FIG. 7 of the accompanying drawings.

Once the choices have been labelled, the method may comprise retrieving 702 the properties for a class of device and forming 703 a subset of the choices which are compatible with all of the devices in a class. For ease of understanding, lets assume that the class is the same as that used in the first example, and that all PDAs in the class can display text and logos but at least one cannot display a chart.

The set that is formed for the PDA class will therefore exclude the choice which contains a chart, even though this is only present in one of the pages and not the other.

Having established the class of choices which can be presented on a class of devices the next step is retrieve 704 the actual properties of a requesting device. From this, the method determines 705 which of any possible choices can be sent to the device. Again, this selection process considers the set of pages in a choice as a whole and will only send pages from a choice of which all pages can be rendered by the requesting device. Thus, regardless of which page is requested the author can ensure that any subsequent pages sent to the device can be from the same set, maintaining the look and feel across a range of pages.

Since each combination may include a page which is shared with another combination, the author can author many different pages and through suitable choices of combinations arrange for their display across a number of classes of device.

Finally, the actual properties of a requesting device are retrieved 704 and the combination from the sub class which contains that device is used to decide which page can be sent 706 to the device. As in the first example, the allowable choices may be arranged according to a hierarchy such that where more than one choice can be sent the highest specification page is sent to the device. If the device asks for a subsequent page, the page which belongs to that combination is then sent so all the pages have the same feel.

It will of course be understood that the method steps of the two examples could readily be performed in a different order and such a different order is intended to fall within the scope of the present invention.

1. A method of authoring a document to be served for rendering on a plurality of classes of device comprising:
defining at least two choices of content which may be styled for a first content portion of the document;
defining at least two choices of content which may be styled for a second content portion of the document; and
labelling the choices of content to indicate approved combinations of content for the first content portion with content for the second content portion.

2. The method of claim 1 in which the step of labelling the content to indicate approved combinations is performed manually by an author.

3. A method according to claim 1 or claim 2 which includes an additional step of arranging the allowable choices into class sub-sets, each class sub-set including only those labelled choices which match the properties of a class of devices on which the web document is to be rendered.

4. The method of claim 3 which comprises defining more than one class sub-set of the approved choices.

5. The method of any one of claims which includes a further step comprising receiving the properties of a device requesting the web document and selecting from the sub-class of combinations which includes the device requesting the document a set of content which matches the properties of the requesting device.

6. The method of claim 5 in which the properties comprise physical properties of the device.

7. The method of any one of claims 3 to 6 in which the step of grouping into sub-classes according to the properties of the device class comprises applying a set of rules to the content forming each combination in order to determine if it is allowable.

8. The method of claim 7 in which a rule which is used comprises checking that the combination of content for the first and second portions fits within a minimum and/or a maximum area available on all of the devices within a class for rendering the content portions.

9. The method of claim 7 or claim 8 in which a different rule which may be applied is to check if all of the content for a combination can be rendered by all of the defined devices within a class.

10. The method of any preceding claim in which a class of devices comprises PDA devices, or PCs or WAP enabled devices.

11. The method according to any preceding claim in which the web document which is authored comprises a web page, a portion of a web page or a set of web pages which are related to one another in some way.

12. The method of any preceding claim in which the choice of content is provided as a separate file or a sub-file of a single file.

13. The method of any preceding claim in which the step of providing content comprises authoring new content.

14. A method according to any preceding claim which includes a step of providing a preference to each approved combination indicating which combination should be used in preference to another combination should more than one combination be suitable for sending to a requesting device.

15. A method according to claim 14 in which the preference is to ensure that the largest size content is always used for a given property of a requesting device

16. A method of any one of claims 14 or claim 15 in which the labels for the approved combinations are used to indicate the preference.

17. The method of any preceding claim which includes the step of transmitting to a device making a request for a web document a web document which includes one of the approved combinations included in the class-subset containing the requesting device which is best suited to that device.

18. A system for authoring a document to be served for rendering on a plurality of classes of device comprising:
a content defining tool for defining at least two choices of content which may be styled, for a first content portion of the document and at least two choices of content, which may be styled, for a second content portion of the document; and
a labelling tool which permits the author to label the choices of content to indicate allowable combinations of content for the first content portion with content for the second content portion.

19. The system of claim 18 in which the content defining tool comprises an editor which permits an author to define the identity and location of existing content choices and/or to author new content.

20. A system according to claim 18 or claim 19 in which the labelling tool is adapted to render automatically selected choices for an author or other user and request the author or user to indicate if the combination is approved.

21. The system of any one of claims 18 to 20 in which a sub-class selection tool is provided which arranges the allowable choices into class sub-sets, each class sub-set including only those labelled choices which match the properties of a class of devices on which the web document is to be rendered.

22. A system according to claim 20 in which the sub-class selection tool includes a device property agent which is adapted to retrieve the properties of devices which form the class of devices for which the sub-class in based.

23. A data structure that is suitable for processing to produce a rendered document, the program comprising:
a content defining section defining at least two choices of content, which may be styled, for a first content portion of the document and at least two choices of content, which may be styled, for a second content portion of the document;
a label section which includes labels corresponding to choices of content, each label indicating an allowable combination of content for the first content portion with content for the second content portion.

24. The data structure of claim 22 in which a sub-class selection section which includes at least one defined class sub-set, each class sub-set including only those labelled choices which match the properties of a class of devices on which the web document is to be rendered.

25. A method of authoring a document to be processed for rendering on a plurality of classes of device substantially as described herein with reference to and as illustrated in the accompanying drawings.

26. A system for authoring a document to be processed for rendering on a plurality of classes of device substantially as described herein with reference to and as illustrated in the accompanying drawings.

27. A data structure that is suitable for processing for rendering a document substantially as described herein with reference to and as illustrated in the accompanying drawings.
